(19) United States
(12) Patent Application Publication
(10) Pub. No.: US 2019/0366948 A1
(43) Pub. Date: Dec. 5, 2019

(54) REAR WINDSHIELD GUTTER ASSEMBLY

(71) Applicant: Derek Jensen, North Ogden, UT (US)

(72) Inventor: Derek Jensen, North Ogden, UT (US)

(21) Appl. No.: 15/997,840

(22) Filed: Jun. 5, 2018

(51) Int. Cl. B60R 13/07; B60S 1/46

(52) U.S. Cl. CPC B60R 13/07; B60S 1/583; B60S 1/46

(57) ABSTRACT

A rear windshield gutter assembly includes a vehicle that has a rear windshield, a rear surface and a rear windshield wiper that is positioned on the rear windshield. The rear windshield wiper includes a wiper fluid dispenser that selectively releases a fluid onto the rear windshield for cleaning the rear windshield. A gutter is coupled to the vehicle and is aligned with the rear windshield. The gutter captures the fluid when the fluid is released onto the rear windshield and directs the fluid to a predetermined drain location. Moreover, the gutter inhibits the fluid from running down the vehicle thereby enhancing visual appearance of the vehicle with respect to inhibiting streaks caused by the fluid on the vehicle.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to gutter devices and more particularly pertains to a new gutter device for diverting wiper fluid away from a rear surface of a vehicle.

### BRIEF SUMMARY OF THE INVENTION

An embodiment of the disclosure meets the needs presented above by generally comprising a vehicle that has a rear windshield, a rear surface and a rear windshield wiper that is positioned on the rear windshield. The rear windshield wiper includes a wiper fluid dispenser that selectively releases a fluid onto the rear windshield for cleaning the rear windshield. A gutter is coupled to the vehicle and is aligned with the rear windshield. The gutter captures the fluid when the fluid is released onto the rear windshield and directs the fluid to a predetermined drain location. Moreover, the gutter inhibits the fluid from running down the vehicle thereby enhancing visual appearance of the vehicle with respect to inhibiting streaks caused by the fluid on the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rear windshield gutter assembly according to an embodiment of the disclosure.

FIG. 2 is a back phantom view of an embodiment of the disclosure.

FIG. 3 is a top view of an embodiment of the disclosure.

FIG. 4 is a left side detail view of an embodiment of the disclosure.

### DETAILED DESCRIPTION OF THE INVENTION

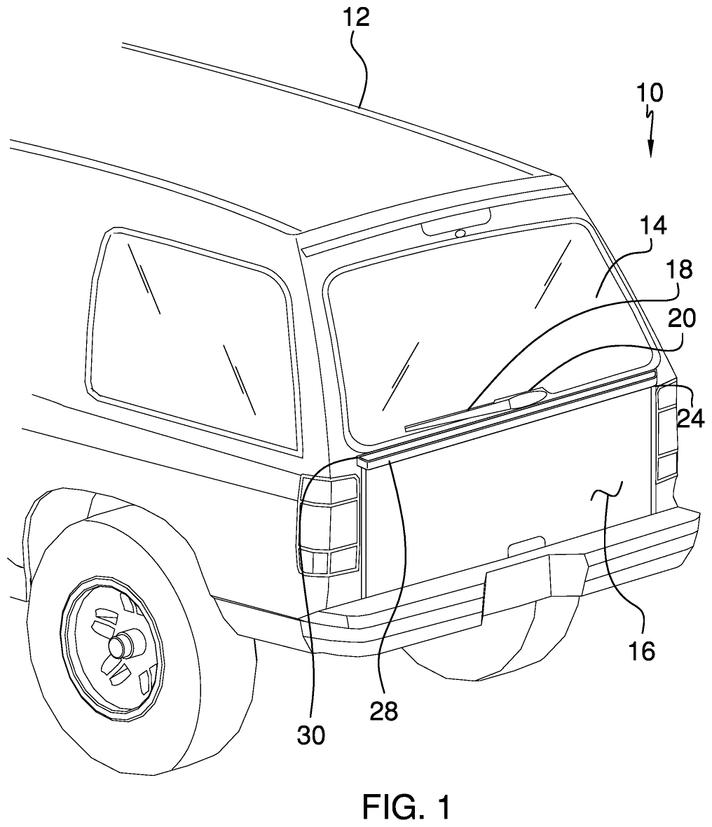

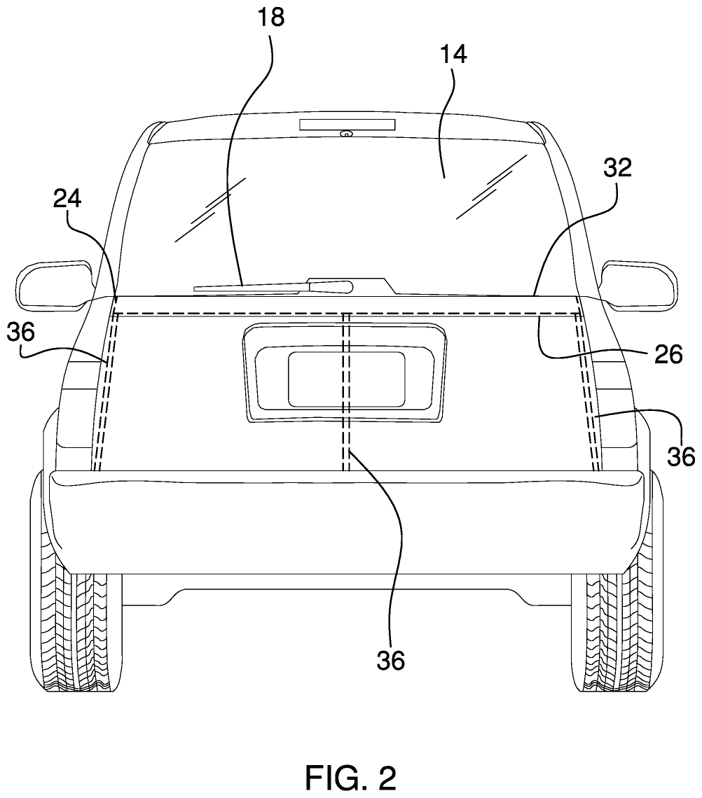

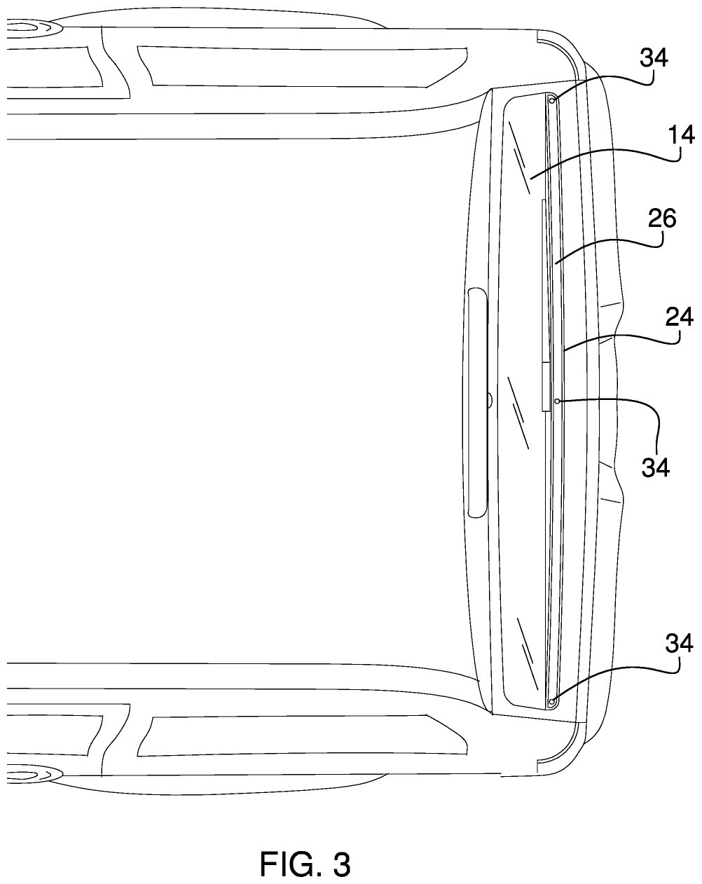

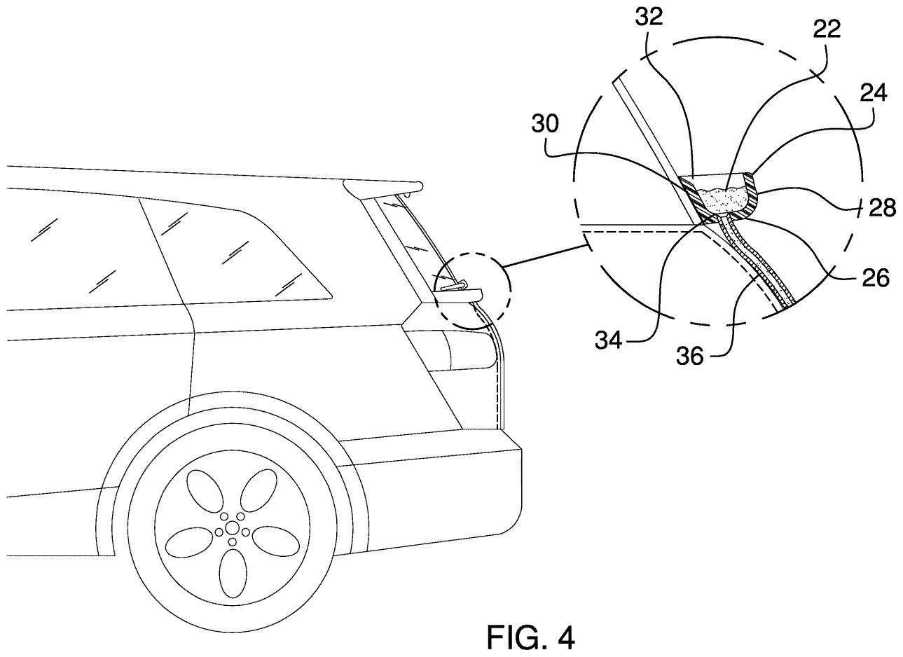

With reference now to the drawings, and in particular to FIGS. 1 through 4 thereof, a new gutter device embodying the principles and concepts of an embodiment of the disclosure and generally designated by the reference numeral 10 will be described.

As best illustrated in FIGS. 1 through 4, the rear windshield gutter assembly 10 generally comprises a vehicle 12 has a rear windshield 14, a rear surface 16 and a rear windshield wiper 18 that is positioned on the rear windshield 14. The rear windshield wiper 18 includes a wiper fluid dispenser 20 that selectively releases a fluid 22 onto the rear windshield 14 for cleaning the rear windshield 14. The vehicle 12 may be a sport utility vehicle or other type of motorized vehicle that has a rear windshield 14 and rear windshield wiper 18. The fluid 22 may be windshield wiper fluid, water and any other type of fluid for cleaning the rear windshield 14.

A gutter 24 is coupled to the vehicle 12 and the gutter 24 is aligned with the rear windshield 14. The gutter 24 captures the fluid 22 when the fluid 22 is released onto the rear windshield 14 and directs the fluid 22 to a predetermined drain location. The predetermined drain location may be a lower edge of the vehicle 12 or a reservoir. The gutter 24 inhibits the fluid 22 from running down the vehicle 12 thereby enhancing the visual appearance of the vehicle 12 with respect to inhibiting streaks caused by the fluid 22 running down the vehicle 12.

The gutter 24 has a bottom wall 26 and an outer wall 28 extending upwardly therefrom, and the outer wall 28 is aligned with and is coextensive with a perimeter of the bottom wall 26. The outer wall 28 has a first side 30 and a distal edge 32 with respect to the bottom wall 26 defining an opening into the gutter 24. The first side 30 is coupled to the rear surface 16 of the vehicle 12 having the gutter 24 being aligned with and being coextensive with an intersection between the rear windshield 14 and the rear surface 16.

The gutter 24 is elongated to extend along an entire width of the rear windshield 14 and the gutter 24 is positioned beneath the rear windshield wiper 18. The bottom wall 26 has a drain 34 extending therethrough for draining the fluid 22 from the gutter 24. A hose 36 is fluidly coupled to the drain 34 and extends to the predetermined drain location. Thus, the hose 36 directs the fluid 22 to the predetermined drain location when the fluid 22 drains from the gutter 24.

In use, the gutter 24 captures the fluid 22 that runs downwardly on the rear windshield 14 when the rear windshield wiper 18 releases the fluid 22 on the rear windshield 14. Thus, the gutter 24 inhibits the fluid 22 from running downwardly along the rear surface 16 of the vehicle 12. In this way the gutter 24 inhibits dirt streaks or other unsightly formations on the vehicle 12 resulting from the fluid 22 running on the vehicle 12. The fluid 22 flows through the drain 34, into the hose 36 and is directed to the predetermined drain location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rear windshield gutter assembly being configured to direct windshield wiper fluid away from a rear surface of a vehicle, said assembly comprising:
a vehicle having a rear windshield, a rear surface and a rear windshield wiper being positioned on said rear windshield, said rear windshield wiper including a wiper fluid dispenser selectively releasing a fluid onto said rear windshield for cleaning said rear windshield; and
a gutter being coupled to said vehicle and being aligned with said rear windshield, said gutter capturing said fluid when the fluid is released onto said rear windshield and directing the fluid to a predetermined drain location, said gutter inhibiting the fluid from running down said vehicle wherein said gutter is configured to enhance visual appearance of said vehicle with respect to inhibiting streaks caused by the fluid on said vehicle.

2. The assembly according to claim 1, further comprising said gutter having a bottom wall and an outer wall extending upwardly therefrom, said outer wall being aligned with and being coextensive with a perimeter of said bottom wall, said outer wall having a first side and a distal edge with respect to said bottom wall defining an opening into said gutter.

3. The assembly according to claim 2, wherein said first side is coupled to said rear surface of said vehicle having said gutter being aligned with and being coextensive with an intersection between said rear windshield and said rear surface, said gutter being positioned beneath said rear windshield wiper.

4. The assembly according to claim 2, wherein said bottom wall has a drain extending therethrough for draining the fluid from said gutter.

5. The assembly according to claim 4, further comprising a hose being fluidly coupled to said drain and extending to said predetermined drain location, said hose directing the fluid to said predetermined drain location when the fluid drains from said gutter.

6. A rear windshield gutter assembly being configured to direct windshield wiper fluid away from a rear surface of a vehicle, said assembly comprising:
a vehicle having a rear windshield, a rear surface and a rear windshield wiper being positioned on said rear windshield, said rear windshield wiper including a wiper fluid dispenser selectively releasing a fluid onto said rear windshield for cleaning said rear windshield;
a gutter being coupled to said vehicle and being aligned with said rear windshield, said gutter capturing said fluid when the fluid is released onto said rear windshield and directing the fluid to a predetermined drain location, said gutter inhibiting the fluid from running down said vehicle wherein said gutter is configured to enhance visual appearance of said vehicle with respect to inhibiting streaks caused by the fluid on said vehicle, said gutter having a bottom wall and an outer wall extending upwardly therefrom, said outer wall being aligned with and being coextensive with a perimeter of said bottom wall, said outer wall having a first side and a distal edge with respect to said bottom wall defining an opening into said gutter, said first side being coupled to said rear surface of said vehicle having said gutter being aligned with and being coextensive with an intersection between said rear windshield and said rear surface, said gutter being positioned beneath said rear windshield wiper, said bottom wall having a drain extending therethrough for draining the fluid from said gutter; and
a hose being fluidly coupled to said drain and extending to said predetermined drain location, said hose directing the fluid to said predetermined drain location when the fluid drains from said gutter.
